(19) United States
(12) Patent Application Publication
(10) Pub. No.: US 2025/0131629 A1
(43) Pub. Date: Apr. 24, 2025

(54) IMAGE PROCESSING DEVICE, IMAGE PROCESSING METHOD, AND IMAGE PROCESSING SYSTEM

(71) Applicant: SEIKO EPSON CORPORATION, Tokyo (JP)

(72) Inventor: Satoshi YAMADA, AZUMINO-SHI (JP)

(21) Appl. No.: 18/918,306

(22) Filed: Oct. 17, 2024

(30) Foreign Application Priority Data
Oct. 19, 2023 (JP) 2023-180075

(51) Int. Cl. G06T 11/60

(52) U.S. Cl. CPC G06T 11/60

(57) ABSTRACT

An image processing device includes an identification information acquisition unit that acquires identification information for identifying a person, an image acquisition unit that acquires a plurality of images, a setting unit that sets a check timing at which the images are checked, and a control unit that generates an album, and the control unit identifies the person included in the images using the identification information, generates person information related to the identified person, compares the person information of the person with set information at the check timing, and outputs notification information indicating that the person information does not satisfy the set information, when the person information does not satisfy the set information.

The present application is based on, and claims priority from JP Application Serial Number 2023-180075, filed Oct. 19, 2023, the disclosure of which is hereby incorporated by reference herein in its entirety.

### BACKGROUND

### 1. Technical Field

The present disclosure relates to an image processing device, an image processing method, and an image processing system.

### 2. Related Art

An image processing device that creates a photo album is known. The image processing device described in JP-A-2020-115305 acquires a plurality of images to be used in a photo album according to an instruction of a user. Each of the plurality of images includes a plurality of people. The image processing device analyzes the acquired images. The image processing device detects people included in the images and counts the number of appearances, and the like. The image processing device lays out the plurality of images according to an instruction of the user. The image processing device selects a predetermined image from the plurality of images based on the number of times a person included in the laid-out images appears. The image processing device selects the predetermined image to set the number of times the person appears as an average number.

When a desired image is not included in the plurality of images, it is difficult for the image processing device to select an image.

### SUMMARY

An image processing device of the present disclosure includes an identification information acquisition unit configured to acquire identification information for identifying a person, an image acquisition unit configured to acquire a plurality of images, a setting unit configured to set a check timing at which the images are checked, and a control unit configured to generate an album, wherein the control unit identifies the person included in the images using the identification information, generates person information related to the identified person, compares the person information of the person with set information at the check timing, and outputs notification information indicating that the person information does not satisfy the set information, when the person information does not satisfy the set information.

An image processing method of the present disclosure includes acquiring identification information for identifying a person included in an image, and a check timing at which the image is checked, acquiring a plurality of the images, identifying the person included in the images using the identification information, storing person information related to the identified person, comparing the stored person information with set information at the check timing, and outputting notification information indicating that the person information does not satisfy the set information, when the person information does not satisfy the set information.

An image processing system of the present disclosure includes an image processing device including an identification information acquisition unit configured to acquire identification information for identifying a person, an image acquisition unit configured to acquire a plurality of images, a setting unit configured to set a check timing at which the images are checked, and a control unit configured to generate an album, and an input and output device operated by a user, wherein the control unit identifies the person included in the images using the identification information, stores person information related to the identified person, compares the stored person information with set information at the check timing, and outputs notification information indicating that the person information does not satisfy the set information to the input and output device, when the person information does not satisfy the set information, and the input and output device receives the notification information and displays the notification information.

### BRIEF DESCRIPTION OF THE DRAWINGS

FIG. 1 is a diagram illustrating a schematic configuration of a photo album creation system.

FIG. 2 is a diagram illustrating a block configuration of the photo album creation system.

FIG. 3 is a diagram illustrating an overview of a captured image.

FIG. 4 is a diagram illustrating an example of an application screen.

FIG. 5 is a diagram illustrating an example of an application screen.

FIG. 6 is a diagram illustrating an example of an application screen.

FIG. 7 is a diagram illustrating an example of an application screen.

FIG. 8 is a diagram illustrating an example of an application screen.

FIG. 9 is a diagram illustrating an example of an application screen.

FIG. 10 is a diagram illustrating an example of an application screen.

FIG. 11 is a diagram illustrating a control flow that is performed by a server.

FIG. 12 is a diagram illustrating a control flow that is performed by the server.

### DESCRIPTION OF EMBODIMENTS

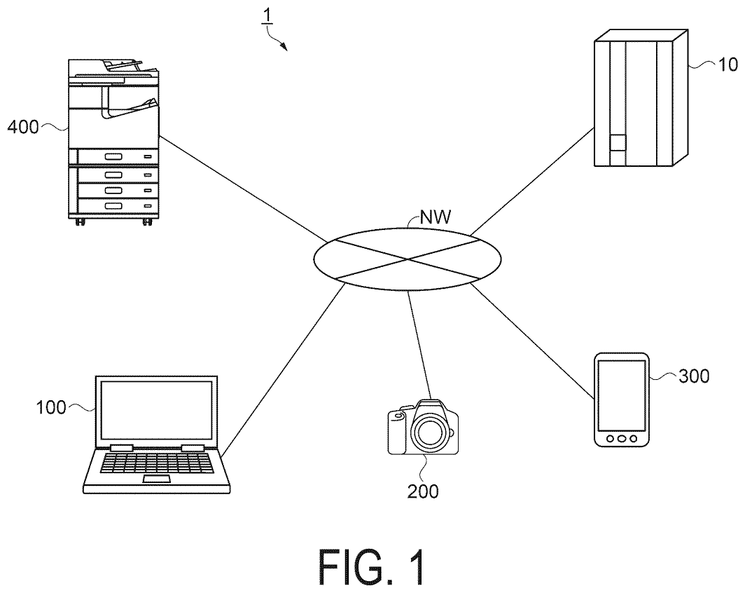

FIG. 1 illustrates a schematic configuration of a photo album creation system 1. The photo album creation system 1 creates various photo albums PA, including a kindergarten graduation album and an elementary school graduation album. The photo album PA corresponds to an example of an album. The photo album creation system 1 includes a server 10, a personal computer 100, a digital camera 200, a smartphone 300, and a printer 400. The server 10, the personal computer 100, the digital camera 200, the smartphone 300, and the printer 400 are communicatively coupled to each other via a communication network NW. The photo album creation system 1 corresponds to an example of an image processing system.

The server 10 generates the photo album PA in a format of electronic data. The server 10 generates the photo album PA in a format such as a portable document format (PDF) or a joint photographic experts group (JPEG) format. The server 10 acquires the imaging data PD from a digital camera 200 or the like. The server 10 generates the photo album PA using the imaging data PD. The server 10 corresponds to an example of an image processing device. The imaging data PD corresponds to an example of an image.

The server 10 illustrated in FIG. 1 is configured as one server device, but the present disclosure is not limited thereto. The server 10 may include a plurality of server devices. The plurality of server devices are coupled to each other via the communication network NW. The server 10 may include a virtualized cloud server.

The personal computer 100 is used by the creator of the photo album PA. The creator uses the personal computer 100 to perform various registration processing, check processing, correction processing, and the like. The personal computer 100 transmits various types of data input by the creator to the server 10. The personal computer 100 outputs various types of data generated by the server 10. The personal computer 100 outputs various types of data using a display unit 120, a speaker (not shown), and the like. The creator corresponds to an example of a user. The personal computer 100 corresponds to an example of an input and output device.

The personal computer 100 illustrated in FIG. 1 is a notebook computer, but the present disclosure is not limited thereto. The personal computer 100 may include a desktop computer or a tablet computer. A configuration of the personal computer 100 is not limited as long as the personal computer 100 can input and output various types of data.

The digital camera 200 images a subject or the like to generate the imaging data PD. The digital camera 200 illustrated in FIG. 1 transmits the imaging data PD to the server 10 via the communication network NW. The digital camera 200 may transmit the imaging data PD to the personal computer 100 via a memory card or a communication cable. The personal computer 100 receives and stores the imaging data PD. The personal computer 100 transmits the imaging data PD to the server 10 via the communication network NW. The photo album creation system 1 illustrated in FIG. 1 includes one digital camera 200, but the present disclosure is not limited thereto. The photo album creation system 1 may include a plurality of digital cameras 200.

The smartphone 300 images a subject or the like to generate the imaging data PD. The smartphone 300 transmits the imaging data PD to the server 10 via the communication network NW. The photo album creation system 1 illustrated in FIG. 1 includes the smartphone 300, but the present disclosure is not limited thereto. The photo album creation system 1 may not include the smartphone 300. The photo album creation system 1 may include a plurality of smartphones 300.

The printer 400 prints the photo album PA generated in a format of electronic data. The printer 400 receives the print data for printing the photo album PA from the server 10 via the communication network NW. The printer 400 prints the photo album PA using the print data. The printer 400 is configured as an inkjet printer or an electrophotographic printer. The printer 400 may include a printed material processing device having a bookbinding function. The printer 400 illustrated in FIG. 1 is coupled to the server 10 via the communication network NW, but the present disclosure is not limited thereto. The printer 400 may be coupled to the server 10 or the personal computer 100 via a coupling cable.

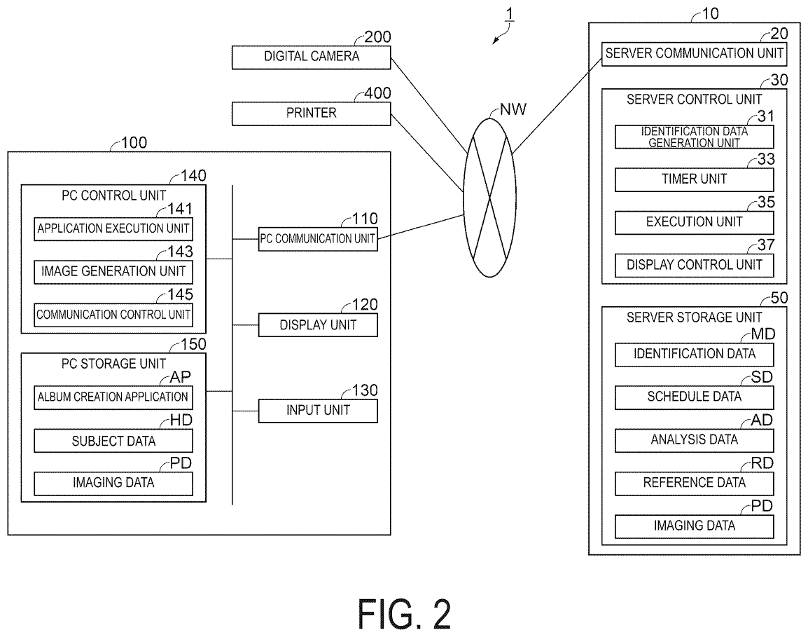

FIG. 2 illustrates a block configuration of the photo album creation system 1. FIG. 2 illustrates the server 10, the personal computer 100, the digital camera 200, and the printer 400. In FIG. 2, the smartphone 300 illustrated in FIG. 1 is omitted.

The server 10 is communicatively coupled to the personal computer 100, the digital camera 200, and the printer 400 via the communication network NW. The server 10 includes a server communication unit 20, a server control unit 30, and a server storage unit 50.

The server communication unit 20 is an interface circuit that is communicatively coupled to the personal computer 100 and the like via the communication network NW. The server communication unit 20 couples to the personal computer 100 and the like by wire or wirelessly according to a predetermined communication protocol. The server communication unit 20 includes a wired connector, a wireless communication port, and the like. The wired connector is a Universal Serial Bus (USB) connector, a Local Area Network (LAN) connector, and the like. The wireless communication port is a Wi-Fi communication port, a Bluetooth communication port, or the like. Wi-Fi and Bluetooth are registered trademarks. The server communication unit 20 receives the imaging data PD and the like from the personal computer 100, the digital camera 200, and the like. The server communication unit 20 transmits various pieces of display data, the print data, and the like to the personal computer 100 and the like.

The server control unit 30 is a controller that controls the server 10. The server control unit 30 is, for example, a processor including a central processing unit (CPU). The server control unit 30 includes one or more processors. The server control unit 30 may include a semiconductor memory such as a random access memory (RAM) or a read only memory (ROM). The semiconductor memory functions as a work area for the server control unit 30. The server control unit 30 operates as various functional units by executing a control program (not shown). The control program is stored in the server storage unit 50 in advance. The server control unit 30 functions as an identification data generation unit 31, a timer unit 33, an execution unit 35, and a display control unit 37 by executing the control program. The server control unit 30 may operate as a functional unit other than the identification data generation unit 31, the timer unit 33, the execution unit 35, and the display control unit 37.

The identification data generation unit 31 acquires identification data MD. The identification data MD is used when identifying a subject corresponding to a subject image HG included in the imaging data PD. The identification data generation unit 31 generates and acquires the identification data MD. When the photo album PA is, for example, an elementary school graduation album, the subjects are children enrolled in the elementary school. The subject corresponds to an example of a person. The identification data generation unit 31 acquires subject data HD related to a subject registered in the personal computer 100. The identification data generation unit 31 acquires one or more pieces of subject data HD. Details of registration of the subject data HD by the creator will be described later. The subject data HD includes a registered image RG. The registered image RG is a facial photograph of the subject and a full-body photograph of the subject. The registered image RG corresponds to an example of a person image. The identification data MD corresponds to an example of identification information. The identification data generation unit 31 corresponds to an example of an identification information acquisition unit.

The identification data generation unit 31 generates the identification data MD using the registered image RG. The identification data MD includes model data such as three-dimensional information of a face that is used for face authentication, or skin information as an example. The model data corresponds to an example of model information. The identification data generation unit 31 generates the identification data MD for each of the plurality of registered images RG. A form of the identification data MD is not limited as long as the identification data MD can distinguish and identify each subject. The identification data generation unit 31 transmits the identification data MD to the server storage unit 50.

The subject data HD includes a registered image RG related to the subject. It is preferable for the identification data generation unit 31 to generate model data using the registered image RG.

The identification data generation unit 31 can accurately identify the subject by generating the model data.

The identification data generation unit 31 may generate the identification data MD using a plurality of pieces of the imaging data PD transmitted from the digital camera 200, and the like. The plurality of pieces of the imaging data PD transmitted from the digital camera 200, and the like are stored in the server storage unit 50. The identification data generation unit 31 reads the imaging data PD from the server storage unit 50 and generates the identification data MD. The identification data generation unit 31 generates the identification data MD by performing machine learning such as deep learning. The identification data generation unit 31 analyzes the imaging data PD. The identification data generation unit 31 extracts a subject that does not correspond to pre-stored identification data MD. The identification data generation unit 31 determines that the extracted subject is an unregistered subject. The identification data generation unit 31 newly generates identification data MD related to the unregistered subject.

The identification data generation unit 31 may update the identification data MD using the plurality of pieces of the imaging data PD transmitted from the digital camera 200 or the like. The identification data generation unit 31 updates the identification data MD by performing machine learning such as deep learning. The identification data generation unit 31 analyzes the imaging data PD. The identification data generation unit 31 analyzes change in the subjects related to the pre-stored identification data MD. The identification data generation unit 31 updates the identification data MD in response to the change in the subjects.

It is preferable for the identification data generation unit 31 to generate the identification data MD using the imaging data PD acquired by the server storage unit 50.

The identification data generation unit 31 may determine the unregistered subject and generate the identification data MD related to the unregistered subject.

The timer unit 33 determines whether an event date and time or an intermediate check date has elapsed. The event data ED indicating the event date and time and the intermediate check date is registered by the creator in advance. Details of the registration of the event data ED will be described later. The timer unit 33 acquires the event data ED. The timer unit 33 sets one or more check timings using the event data ED. The check timing is an end time of the event or a time when a predetermined time has elapsed since the end time of the event. The check timing is a predetermined time within the intermediate check date or a predetermined date and time after the intermediate check date. The check timing is a timing at which the creator checks the captured image PG or the photo album PA. The timer unit 33 generates schedule data SD including one or more check timings. The timer unit 33 generates the schedule data SD based on preset conditions. The timer unit 33 measures a date and time. When the timer unit 33 determines that the check timing included in the schedule data SD has arrived, the timer unit 33 transmits an arrival signal to the execution unit 35, the display control unit 37, and the like. The arrival signal is a signal indicating that the check timing has elapsed. The timer unit 33 corresponds to an example of a setting unit.

The execution unit 35 generates the photo album PA. The execution unit 35 may generate an event album PA1 constituting a part of the photo album PA. The execution unit 35 generates the photo album PA using the imaging data PD stored in the server storage unit 50. The execution unit 35 generates the photo album PA by selecting and editing the imaging data PD based on creation conditions that have been set in advance. The creation conditions are the number of captured images PG included in the photo album PA, the number of captured images PG for each subject, a layout of the captured images PG, and the like. The execution unit 35 may generate and edit the photo album PA based on an instruction from the creator. The execution unit 35 corresponds to an example of a control unit. The event album PA1 corresponds to an example of a partial album.

The execution unit 35 may create the plurality of event albums PAL as creation samples of the event album PA1. The plurality of event albums PA1 include a first event album PA1A and a second event album PA1B. The first event album PA1A corresponds to an example of a first candidate. The second event album PA1B corresponds to an example of a second candidate. When the execution unit 35 creates the plurality of event albums PA1, the execution unit 35 outputs the plurality of event albums PA1 to the personal computer 100. The personal computer 100 displays the plurality of event albums PA1. The creator can check and compare the plurality of event albums PA1. The creator can select the preferred event album PAL from the plurality of event albums PA1.

It is preferable for the execution unit 35 to generate the first event album PALA and the second event album PA1B as the event album PA1, and output the first event album PALA and the second event album PA1B.

The creator can select the preferred event album PA1 from the plurality of event albums PA1.

The execution unit 35 uses the identification data MD to identify the subject included in the imaging data PD indicating the captured image PG. The execution unit 35 acquires the identification data MD generated by the identification data generation unit 31. The execution unit 35 uses the identification data MD to identify the subject included in the imaging data PD. The execution unit 35 may analyze a position of the identified subject, an imaging area, a posture, and the like of the subject in the imaging data PD. When one piece of the imaging data PD includes a plurality of subjects, the execution unit 35 identifies each subject. The execution unit 35 may analyze the imaging area, the posture, and the like for each subject.

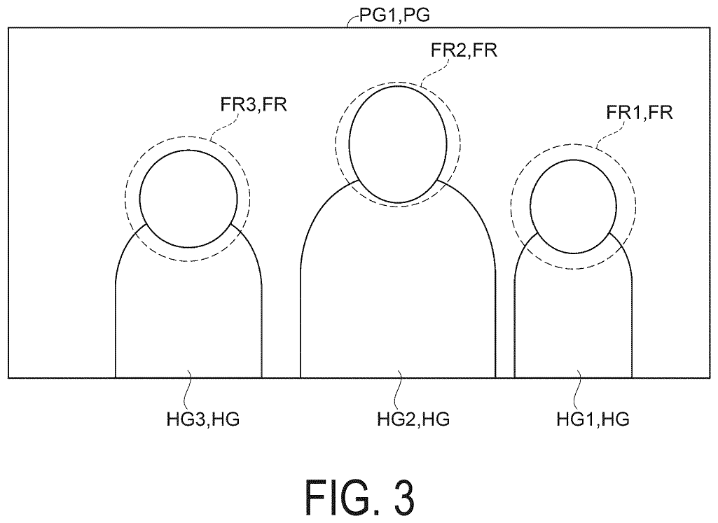

FIG. 3 illustrates an overview of the captured image PG. FIG. 3 illustrates a first captured image PG1, which is an example of the captured image PG. The captured image PG including the first captured image PG1 is captured by the digital camera 200, the smartphone 300, and the like. The digital camera 200, the smartphone 300, and the like generate the imaging data PD indicating the captured image PG. The digital camera 200, the smartphone 300, and the like transmit the imaging data PD to the server 10. The execution unit 35 of the server 10 acquires the imaging data PD. FIG. 3 illustrates the first captured image PG1 including three subjects as an example.

The execution unit 35 identifies the subject image HG included in the imaging data PD related to the first captured image PG1. The imaging data PD related to the first captured image PG1 illustrated in FIG. 3 includes a first subject image HG1, a second subject image HG2, and a third subject image HG3 as the subject image HG. The execution unit 35 specifies the first subject image HG1, the second subject image HG2, and the third subject image HG3.

The execution unit 35 extracts a face image region FR of each subject image HG after specifying the subject image HG. The execution unit 35 extracts the first face image region FR1, the second face image region FR2, and the third face image region FR3 from the imaging data PD. The first face image region FR1 is a region including the face image of the first subject image HG1. The second face image region FR2 is a region including the face image of the second subject image HG2. The third face image region FR3 is a region including the face image of the third subject image HG3.

The execution unit 35 reads the identification data MD from the server storage unit 50. The execution unit 35 performs face authentication on the face image included in the face image region FR using the identification data MD. The execution unit 35 identifies each subject image HG by performing face authentication. The execution unit 35 performs face authentication on the face image included in each of the first face image region FR1, the second face image region FR2, and the third face image region FR3. The execution unit 35 identifies the subject corresponding to each of the first subject image HG1, the second subject image HG2, and the third subject image HG3 by performing the face authentication on each face image in the face image region FR. The execution unit 35 generates identification information for identifying the subject for the imaging data PD.

The execution unit 35 illustrated in FIG. 2 identifies the subject included in the imaging data PD for each of the plurality of pieces of the imaging data PD stored in the server storage unit 50 and generates identification information. The execution unit 35 may analyze, for example, the imaging area of the subject included in the imaging data PD for each of the plurality of pieces of the imaging data PD stored in the server storage unit 50, and generate analysis information. When the server storage unit 50 classifies and stores the plurality of pieces of imaging data PD into folders, the execution unit 35 may identify the subjects included in the imaging data PD stored in the folder for each folder. When the execution unit 35 has created the event album PA1, the execution unit 35 may perform identification of the subject on the imaging data PD included in the event album PA1 to generate identification information. When the execution unit 35 creates the event album PA1, the execution unit 35 may generate analysis information by analyzing the imaging area of the subject for the imaging data PD included in the event album PA1.

The execution unit 35 generates the analysis data AD using the identification information. The analysis data AD includes the number of pieces of the imaging data PD including the subject. The execution unit 35 may generate the analysis data AD using analysis information obtained by analyzing the imaging data PD. The analysis information includes the imaging area, imaging position, and the like of the subject. The analysis data AD includes an average imaging area, which is an average value of the imaging area analyzed for each piece of the imaging data PD, an average imaging position, which is an average value of the imaging position analyzed for each piece of the imaging data PD, and the like. The analysis data AD includes data corresponding to each of the plurality of subjects. The analysis data AD corresponds to an example of person information. The execution unit 35 transmits the analysis data AD to the server storage unit 50. The server storage unit 50 stores the analysis data AD.

When the execution unit 35 generates the event album PA1, the analysis data AD is generated by analyzing the imaging data PD included in the event album PA1. The analysis data AD includes the number of pieces of the imaging data PD of each subject, and the like. The execution unit 35 may generate the analysis data AD based on analysis information of the imaging data PD included in the event album PA1.

It is preferable for the execution unit 35 to generate the analysis data AD for each event album PA1 when the execution unit 35 generates the plurality of event albums PA1. The execution unit 35 stores the analysis data AD in the server storage unit 50 in association with each of the plurality of event albums PA1.

The execution unit 35 acquires the imaging data PD at a predetermined timing and generates the analysis data AD. When the server communication unit 20 receives the imaging data PD, the execution unit 35 may acquire the imaging data PD. The execution unit 35 may acquire the imaging data PD from the server storage unit 50 at predetermined time intervals. The execution unit 35 may acquire the imaging data PD from the server storage unit 50 when the arrival signal is received. When the execution unit 35 acquires the imaging data PD, the execution unit 35 generates or updates the analysis data AD.

When the execution unit 35 receives the arrival signal, the execution unit 35 compares the analysis data AD with the reference data RD. As an example, the execution unit 35 compares the number of pieces of imaging data PD including the subject included in the analysis data AD with the reference data RD. The reference data RD may be a preset value or may be a value generated based on the analysis data AD. When the creator registers the creation conditions for creating the photo album PA in advance, the reference data RD may be included in the creation conditions. As an example, the execution unit 35 calculates an average value obtained by averaging the number of pieces of imaging data PD of each of the plurality of subjects included in the analysis data AD. The execution unit 35 sets a predetermined numerical value range including the average value as the reference data RD. The analysis data AD and the reference data RD are not limited to the number of pieces of the imaging data PD including the subject. The execution unit 35 may use, for example, a value calculated from the analysis information such as the imaging area and posture of the subject to perform the comparison. The execution unit 35 is not limited in form as long as a frequency of the photo album PA for each subject can be evaluated by comparing the analysis data AD with the reference data RD. The reference data RD corresponds to an example of set information.

The execution unit 35 determines whether or not the analysis data AD satisfies the reference data RD by comparing the analysis data AD with the reference data RD. When the analysis data AD is within a range of the reference data RD, the execution unit 35 determines that the analysis data AD satisfies the reference data RD. When the analysis data AD is outside the range of the reference data RD, the execution unit 35 determines that the analysis data AD does not satisfy the reference data RD.

The reference data RD is, for example, a numerical value range including an average value obtained by averaging the number of pieces of the imaging data PD for each of a plurality of subjects. The execution unit 35 compares the number of pieces of the imaging data PD of each of the plurality of subjects included in the analysis data AD with the numerical value range. The number of pieces of the imaging data PD corresponds to an example of the number of images. When the number of pieces of the imaging data PD of one of the plurality of subjects is smaller than a lower limit of the numerical value range, the execution unit 35 determines that the number of pieces of the imaging data PD of the subject does not satisfy the reference data RD. The lower limit of the numerical value range is a lower limit of the number of pieces of the imaging data PD, and corresponds to an example of a threshold. When the number of pieces of the imaging data PD of the one of the plurality of subjects is larger than an upper limit of the numerical value range, the execution unit 35 may determine that the number of pieces of the imaging data PD of the subject does not satisfy the reference data RD. The execution unit 35 compares the number of pieces of the imaging data PD of each of the plurality of subjects with the numerical value range including the average value. The execution unit 35 determines whether or not the number of pieces of the imaging data PD of each of the plurality of subjects satisfies the reference data RD.

The reference data RD may be a frequency range including a frequency average obtained by averaging the frequencies of the plurality of subjects. The frequency is, for example, a point value obtained by converting analysis information such as the imaging area and posture of the subject into a point based on a preset calculation formula. The frequency average is obtained by calculating an average of point values of a plurality of subjects. The execution unit 35 determines whether or not the analysis data AD satisfies the reference data RD by comparing a frequency of each of the plurality of subjects with the frequency range.

When the execution unit 35 determines that the analysis data AD does not satisfy the reference data RD, the execution unit 35 outputs warning information to the display control unit 37. The warning information is information indicating that the analysis data AD does not satisfy the reference data RD. The warning information is information for causing a predetermined message to be output to the creator. The analysis data AD includes subject information indicating the number of pieces of the imaging data PD related to each of the plurality of subjects, the analysis information, and the like. When the execution unit 35 determines that one or more of pieces of subject information related to the plurality of subjects do not satisfy the reference data RD, the execution unit 35 outputs the warning information to the display control unit 37.

The execution unit 35 may generate and output the print data for printing the photo album PA. The execution unit 35 generates the print data using the photo album PA in an electronic data format. The execution unit 35 outputs the print data to the server communication unit 20. The server communication unit 20 transmits the print data to the printer 400 via the communication network NW. The execution unit 35 transmits the print data to the printer 400 so that the printer 400 prints the photo album PA. The execution unit 35 may transmit the print data to the personal computer 100.

The execution unit 35 may generate and output the print data for printing the event album PA1. The execution unit 35 generates the print data using the event album PA1 in an electronic data format. The execution unit 35 outputs the print data to the server communication unit 20. The server communication unit 20 transmits the print data to the printer 400 via the communication network NW. The execution unit 35 transmits the print data to the printer 400 so that the printer 400 prints the event album PA1.

The execution unit 35 preferably generates and outputs the print data for printing the generated photo album PA.

The creator can obtain a printed material on which the photo album PA has been printed.

The display control unit 37 generates message data for displaying various messages to the creator who operates the personal computer 100. The various messages include a warning message 537 based on the warning information. The display control unit 37 receives the warning information from the execution unit 35. When the display control unit 37 receives the warning information, the display control unit 37 generates warning message data for displaying the warning message 537. The warning message 537 is a message indicating that the analysis data AD does not satisfy the reference data RD. The display control unit 37 transmits the warning message data to the personal computer 100. The display control unit 37 causes the personal computer 100 to display the warning message 537 by transmitting the warning message data to the personal computer 100. The warning message 537 and the warning message data correspond to examples of the notification information.

The display control unit 37 may generate various pieces of display data and transmit the display data to the personal computer 100. As an example, the display control unit 37 acquires the analysis data AD from the execution unit 35 or the server storage unit 50. The display control unit 37 generates display data using the analysis data AD. The display control unit 37 may generate display data other than the display data generated using the analysis data AD. The display control unit 37 transmits the display data to the personal computer 100 and causes the personal computer 100 to display the display data.

The server control unit 30 may include a sound control unit (not shown). The sound control unit receives the warning information from the execution unit 35. When the sound control unit receives the warning information, the sound control unit generates warning sound data for causing a warning sound to be output. The warning sound data is sound data indicating that the analysis data AD does not satisfy the reference data RD. The sound control unit transmits the warning sound data to the personal computer 100. The sound control unit causes the personal computer 100 to output the warning sound by transmitting the warning sound data to the personal computer 100.

The server storage unit 50 stores various types of data, various programs, and the like. The server storage unit 50 is configured of a volatile semiconductor memory such as a RAM, a non-volatile memory such as a ROM or a flash memory, and the like. The server storage unit 50 may include a magnetic memory such as a hard disk drive (HDD). The server storage unit 50 stores the identification data MD, the schedule data SD, the analysis data AD, and the reference data RD. The server storage unit 50 stores a plurality of pieces of the imaging data PD. The server storage unit 50 acquires and stores the imaging data PD transmitted from the digital camera 200 or the like to the server communication unit 20. The server storage unit 50 may store various pieces of display data, the print data, and the like. The server storage unit 50 corresponds to an example of an image acquisition unit.

The identification data MD is generated by the identification data generation unit 31. The identification data MD identifies the subject related to the subject image HG included in the captured image PG. The server storage unit 50 stores the identification data MD in association with an identification code CN of the subject. The identification code CN will be described later. The server storage unit 50 may store the identification data MD and the identification code CN in a table format.

The schedule data SD is generated by the timer unit 33. The schedule data SD is generated using the event data ED transmitted from the personal computer 100. The schedule data SD includes one or more check timings. The timer unit 33 may set information included in the event data ED as the check timing, and generate the schedule data SD. The schedule data SD is generated by the timer unit 33 for each of the event date and time and the intermediate check date transmitted from the personal computer 100.

The analysis data AD is generated by the execution unit 35. The analysis data AD is generated using the identification information and analysis information for each of the pieces of imaging data PD. The analysis data AD includes the number, frequency, and the like of the imaging data PD for each of the plurality of subjects. The server storage unit 50 may store a table in which the identification code CN of the subject is associated with the imaging data PD, which is included in the analysis data AD.

The reference data RD is data to be compared with the analysis data AD. The reference data RD is a value that is set in advance, or a value calculated using identification information, and the like. The reference data RD is expressed by one or more numerical values, or a numerical value range. The execution unit 35 may update the reference data RD when the execution unit 35 receives the arrival signal.

The imaging data PD is transmitted from the digital camera 200, and the like, via the communication network NW. The server storage unit 50 stores the plurality of pieces of the imaging data PD. The server storage unit 50 may classify the plurality of pieces of the imaging data PD depending on an imaging date and time of the imaging data PD and store the plurality of pieces of the imaging data PD. As an example, the server storage unit 50 classifies the plurality of pieces of the imaging data PD depending on the imaging date and time and stores the imaging data PD in the folder. The server storage unit 50 may store the imaging data PD and the identification information of the imaging data PD in association with each other.

The personal computer 100 is operated by the creator. The personal computer 100 receives various types of input data input by the creator. The personal computer 100 transmits the various types of input data to the server 10, and the like via the communication network NW. The personal computer 100 receives display data or the like transmitted from the server 10. The personal computer 100 outputs various types of information to the creator using the display data or the like. The personal computer 100 corresponds to an example of an input and output device. The personal computer 100 includes a PC communication unit 110, a display unit 120, an input unit 130, a PC control unit 140, and a PC storage unit 150. PC is an abbreviation for a personal computer.

The PC communication unit 110 is an interface circuit that is communicatively coupled to the server 10 and the like via the communication network NW. The PC communication unit 110 is coupled to the server 10 and the like by a cable or wirelessly according to a predetermined communication protocol. The PC communication unit 110 includes a wired connector, a wireless communication port, and the like. The wired connector is a USB connector, a LAN connector, or the like. The wireless communication port is a Wi-Fi communication port, a Bluetooth communication port, or the like. The PC communication unit 110 receives various types of data such as display data from the server 10. The PC communication unit 110 may also receive the imaging data PD, and the like from the digital camera 200 and the like. The PC communication unit 110 transmits, for example, input data input by the creator using the input unit 130 to the server 10 or the like. The PC communication unit 110 may transmit the imaging data PD to the server 10.

The display unit 120 displays various types of data. The display unit 120 includes various display devices such as a liquid crystal display and an organic electroluminescence (EL) display. The display unit 120 may be configured integrally with the personal computer 100 or may be configured as a separate external unit with respect to the personal computer 100. The display unit 120 may have a touch input function. When the display unit 120 has the touch input function, the display unit 120 operates as the input unit 130.

The input unit 130 is operated by the creator. The creator operates the input unit 130 to input various types of input data to the personal computer 100. The input unit 130 is configured of a device such as a mouse, a keyboard, and a liquid crystal tablet. The input unit 130 may be configured integrally with the personal computer 100 or may be configured as a separate external unit.

The PC control unit 140 is a controller that controls the personal computer 100. As an example, the PC control unit 140 is a processor having a CPU. The PC control unit 140 is configured with one or more processors. The PC control unit 140 may include a semiconductor memory such as a ROM or a RAM. The semiconductor memory functions as a work area for the PC control unit 140. The PC control unit 140 operates as various functional units by executing an album creation application AP. As an example, the album creation application AP is stored in the PC storage unit 150 in advance. The PC control unit 140 functions as an application execution unit 141, a screen generation unit 143, and a communication control unit 145 by executing the album creation application AP. The PC control unit 140 may operate as a functional unit other than the application execution unit 141, the screen generation unit 143, and the communication control unit 145.

The application execution unit 141 generates various types of registration data based on the input data. The application execution unit 141 controls the screen generation unit 143 to cause various application screens 500 to be displayed on the display unit 120. The creator operates the application screen 500 displayed on the display unit 120 to input the input data. The application execution unit 141 acquires the input data and generates various types of registration data based on the input data. The application execution unit 141 generates the subject data HD, the event data ED, and the like as the registration data. The application execution unit 141 may generate the registration data different from the subject data HD and the event data ED. The application execution unit 141 transmits the registration data to the communication control unit 145. The application execution unit 141 controls the communication control unit 145 to cause the registration data to be transmitted to the server 10 via the PC communication unit 110.

The application execution unit 141 causes the creator to execute, for example, editing and checking of the photo album PA. The application execution unit 141 acquires the display data transmitted from the server 10. The display data includes display data for displaying the photo album PA, message data including the warning message 537, and the like. The application execution unit 141 may acquire display data for displaying the analysis data AD. The application execution unit 141 causes the screen generation unit 143 to display various pieces of display data and message data on the display unit 120. The application execution unit 141 may acquire display data for displaying the event album PA1. The application execution unit 141 causes the display data for displaying the event album PA1 to be displayed on the display unit 120.

The screen generation unit 143 generates various application screens 500 related to the album creation application AP. The screen generation unit 143 causes the application screen 500 to be displayed on the display unit 120. The screen generation unit 143 prompts the creator to input various types of input data by displaying the application screen 500 on the display unit 120. The screen generation unit 143 prompts the creator to edit and check the photo album PA, and the like by causing the application screen 500 to be displayed on the display unit 120. Details of the application screen 500 generated by the screen generation unit 143 will be described later.

The communication control unit 145 controls communication with the server 10, and the like. The communication control unit 145 controls various types of data transmitted from the PC communication unit 110 to the server 10, and the like, a data transmission timing, and the like. The communication control unit 145 controls reception of various types of data transmitted from the server 10, and the like to the PC communication unit 110. The communication control unit 145 controls a transmission destination of the received data. As an example, the communication control unit 145 transmits the imaging data PD transmitted from the digital camera 200 to the PC storage unit 150 via the communication network NW. The communication control unit 145 transmits the imaging data PD stored in the PC storage unit 150 to the server 10 at a predetermined timing via the communication network NW.

The PC storage unit 150 stores various types of data, various applications, and the like. The PC storage unit 150 is configured of a volatile semiconductor memory such as a RAM, a non-volatile memory such as a ROM or a flash memory, and the like. The PC storage unit 150 may include a magnetic memory such as an HDD. The PC storage unit 150 stores an application such as the album creation application AP, and registration data such as a registered image RG. The PC storage unit 150 may store the imaging data PD.

The album creation application AP is an application that causes the PC control unit 140 to function as various functional units such as the application execution unit 141. The album creation application AP may be a web application that operates on a web browser. The creator can create the photo album PA by starting the album creation application AP.

The subject data HD is registered by the creator before the photo album PA is created. The subject data HD is data related to the subject. The subject data HD includes a registered image RG, which is an image related to the subject. The subject data HD is used by the identification data generation unit 31 of the server 10. The subject data HD is input by the creator using the application screen 500, and is stored in the PC storage unit 150. As an example, the subject data HD is stored in the PC storage unit 150 in a table format in which the registered image RG and the identification code CN are associated with each other. The subject data HD is transmitted to the server 10 via the communication network NW.

The imaging data PD stored in the PC storage unit 150 is transmitted to the server 10 via the personal computer 100. The digital camera 200 is locally coupled to the personal computer 100 via a cable or the like. When the digital camera 200 transmits the imaging data PD to the personal computer 100 via the cable, the imaging data PD is stored in the PC storage unit 150. When the personal computer 100 has an imaging function of an imaging unit or the like, the PC storage unit 150 stores the imaging data PD captured by the imaging unit.

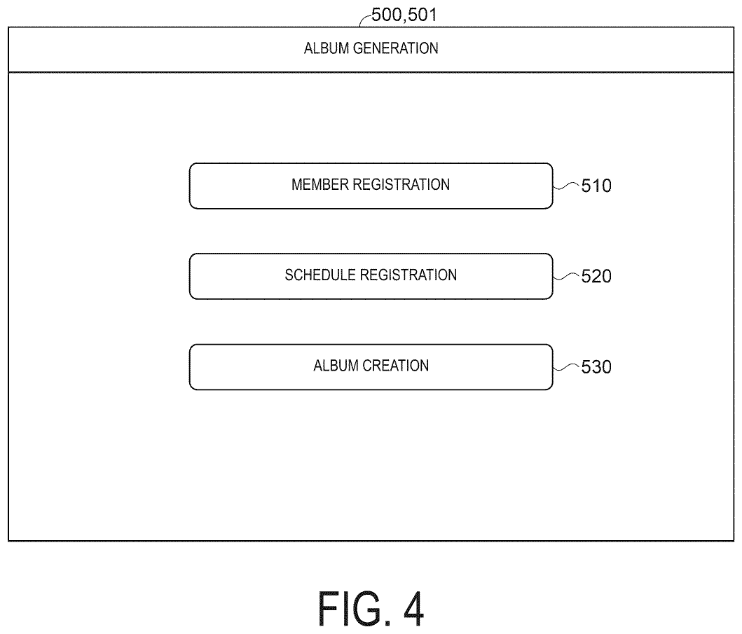

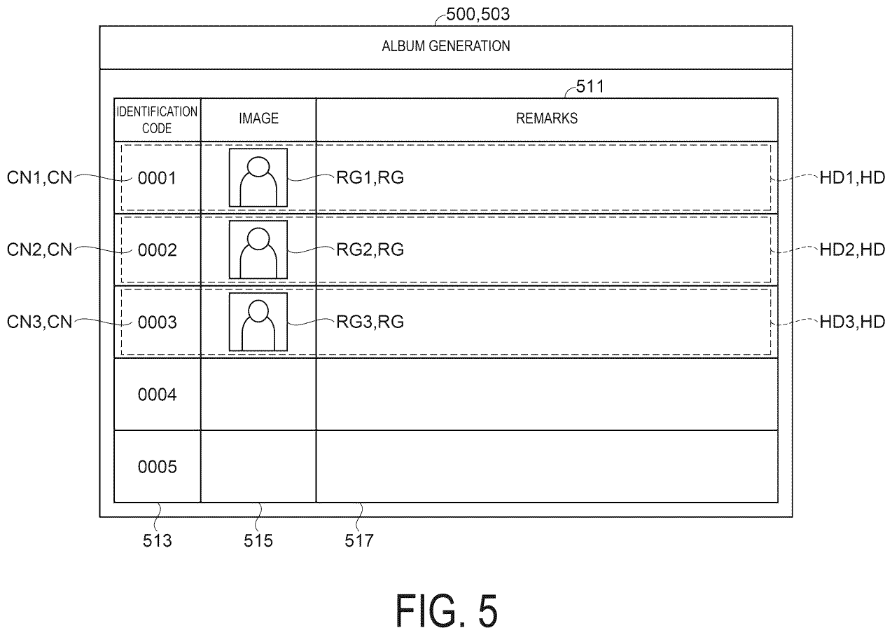

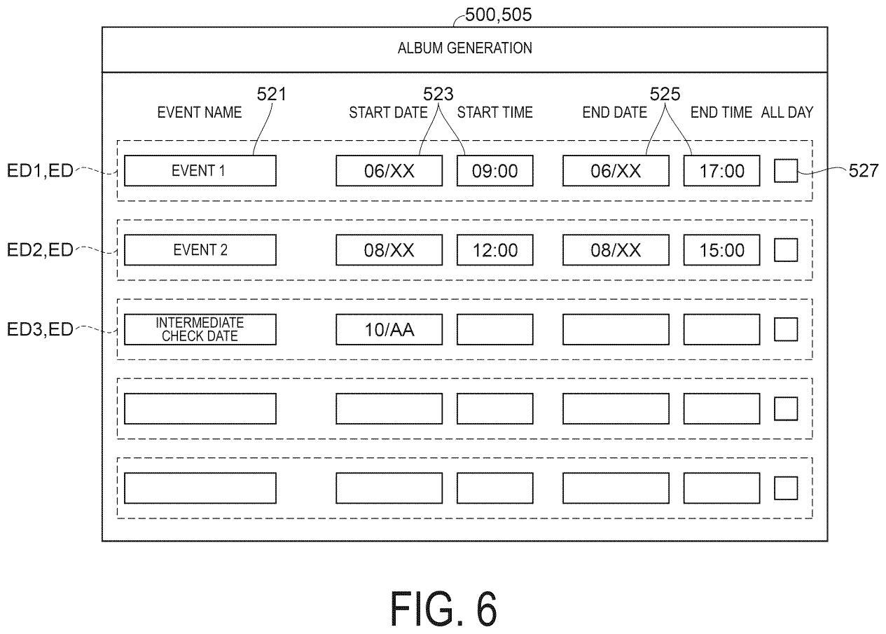

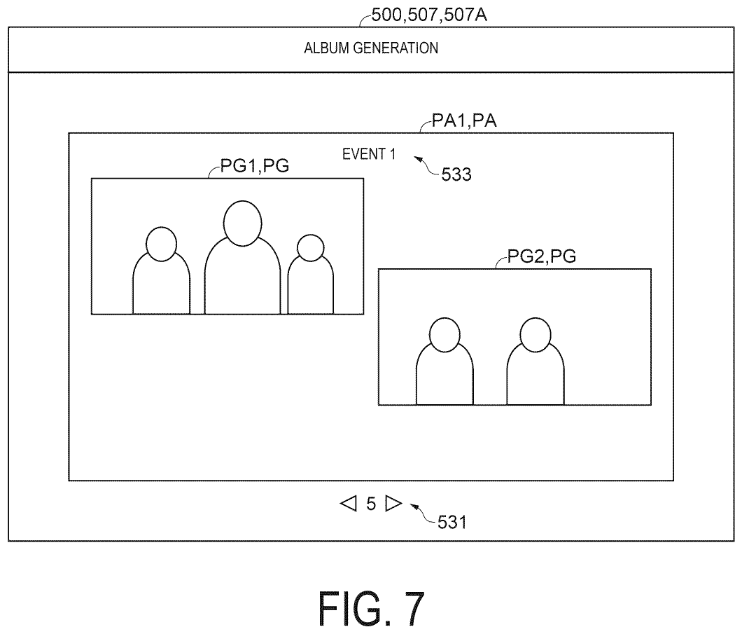

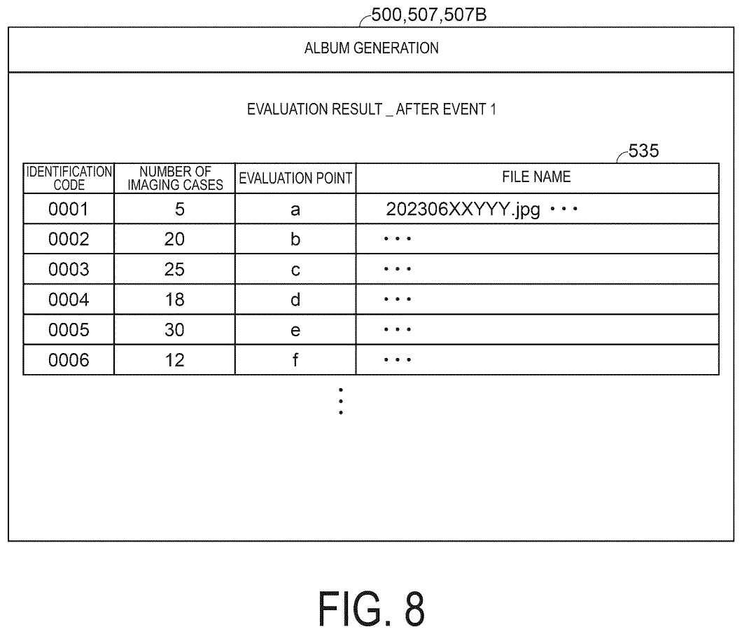

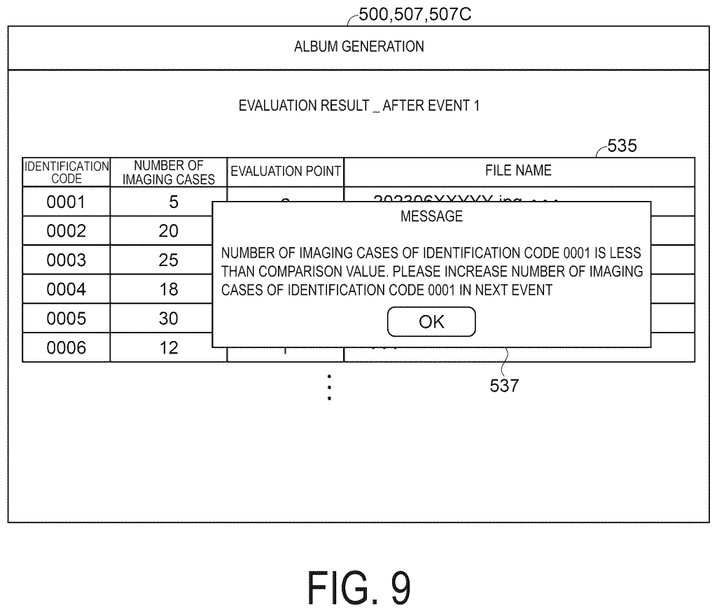

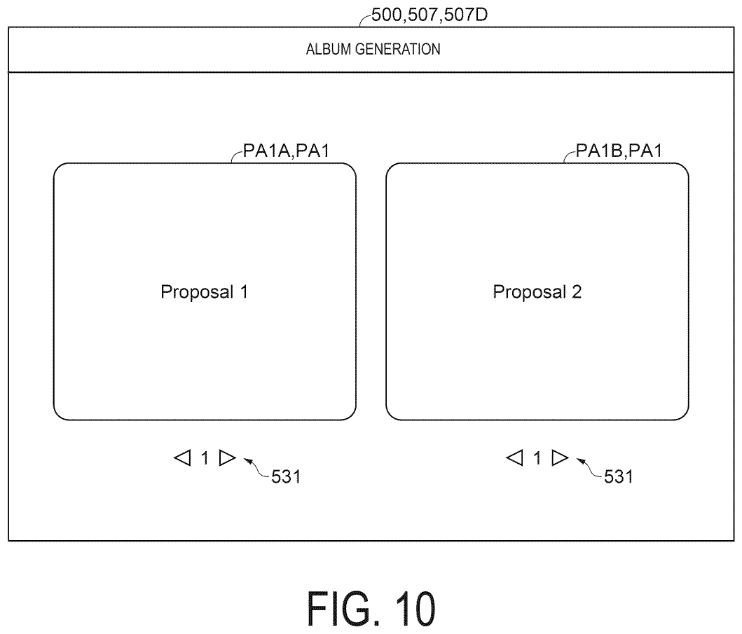

FIGS. 4, 5, 6, 7, 8, 9, and 10 show examples of the application screen 500. The application screen 500 illustrated in FIG. 4, FIG. 5, FIG. 6, FIG. 7, FIG. 8, FIG. 9, and FIG. 10 can be displayed on the display unit 120 when the PC control unit 140 executes the album creation application AP. The application screen 500 is generated by the screen generation unit 143 and displayed on the display unit 120.

FIG. 4 illustrates an application initial screen 501, which is one of the application screens 500. The application initial screen 501 is displayed on the display unit 120 when the PC control unit 140 executes the album creation application AP. The application initial screen 501 displays a member registration icon 510, a schedule registration icon 520, and an album creation icon 530.

The member registration icon 510 is an icon that the creator operates when registering a subject. The member registration icon 510 is operated by the creator at the time of initial setting before the creation of the photo album PA starts. When the creator operates the member registration icon 510 using the input unit 130, a member registration screen 503 illustrated in FIG. 5 is displayed on the display unit 120.

The schedule registration icon 520 is an icon that the creator operates when registering the event data ED including the event date and time, and the like. The schedule registration icon 520 is operated by the creator at the time of initial setting before the creation of the photo album PA starts. When the creator operates the schedule registration icon 520 using the input unit 130, the schedule registration screen 505 illustrated in FIG. 6 is displayed on the display unit 120.

The album creation icon 530 is an icon that is operated when the photo album PA is edited and checked. When the creator performs, for example, editing of the photo album PA or the event album PA1 that is being created, the album creation icon 530 is operated by the creator. When the creator operates the album creation icon 530 using the input unit 130, an album creation screen 507 illustrated in FIG. 7, FIG. 8, FIG. 9, and FIG. 10 is displayed on the display unit 120.

FIG. 5 illustrates the member registration screen 503, which is one of the application screens 500. The member registration screen 503 is a screen for registering the subject data HD including the registered image RG of the subject and the like. The creator uses the member registration screen 503 to input text information and image information included in the subject data HD. The member registration screen 503 illustrated in FIG. 5 shows a member registration table 511. The member registration table 511 includes a plurality of input columns and a plurality of input rows. The input columns include a code input field 513, an image input field 515, and a remark input field 517. The input columns may include input fields other than the code input field 513, the image input field 515, and the remark input field 517. Each of the plurality of input rows corresponds to the subject data HD of each subject.

The code input field 513 is a field to which the identification code CN is input. The identification code CN is a unique code indicating each subject. The identification code CN illustrated in FIG. 5 is input in a consecutive number in order of rows, but the present disclosure is not limited thereto. A form of the code input field 513 is not limited as long as a code such as an employee code or a student code that can distinguish between subjects can be input. A name of the subject may be input to the code input field 513. The identification code CN illustrated in FIG. 5 is input in advance by the album creation application AP, but may be input manually by the creator. A first identification code CN1 is input to a first row of the member registration table 511 illustrated in FIG. 5, a second identification code CN2 is input to a second row, and a third identification code CN3 is input to a third row.

The image input field 515 is a field in which the registered image RG of the subject is displayed. The creator captures each registered image RG of the subject in advance and stores the registered image RG in the PC storage unit 150. When the creator inputs a file name corresponding to the registered image RG to the image input field 515, the registered image RG is displayed in the image input field 515. In the member registration table 511 illustrated in FIG. 5, a first registered image RG1 is registered in a first row, a second registered image RG2 is registered in a second row, and a third registered image RG3 is registered in a third row. The image input field 515 illustrated in FIG. 5 displays one registered image RG per row, but the present disclosure is not limited thereto. The creator may input a plurality of registered images RG to each row of the image input field 515. The registered image RG illustrated in FIG. 5 shows an image of an upper body of the subject, but the present disclosure is not limited thereto. An imaging target for the registered image RG is not limited as long as the registered image RG is an image from which the identification data MD can be generated by the identification data generation unit 31 of the server 10.

The remark input field 517 is a field to which information related to each subject can be input. A name, affiliation, a relationship with other subjects, and the like of the subject can be input to the remark input field 517. The member registration table 511 illustrated in FIG. 5 shows the remark input field 517, but the present disclosure is not limited thereto. The member registration table 511 may not include the remark input field 517.

When the creator inputs the registered image RG and the like to the member registration table 511, the application execution unit 141 acquires input data. The application execution unit 141 generates first subject data HD1 including the first identification code CN1 input to the first row of the member registration table 511, and the first registered image RG1. The application execution unit 141 generates second subject data HD2 including the second identification code CN2 input to the second row of the member registration table 511, and the second registered image RG2. The application execution unit 141 generates third subject data HD3 including the third identification code CN3 input to the third row of the member registration table 511, and the third registered image RG3. When the creator inputs the identification code CN and the identification image RG to each row after a fourth row, the application execution unit 141 generates the subject data HD for each row. The application execution unit 141 may generate the subject data HD including the data input to the remark input field 517. The application execution unit 141 transmits the subject data HD to the server 10 via the PC communication unit 110 at a predetermined timing.

FIG. 6 illustrates a schedule registration screen 505, which is one of the application screens 500. The schedule registration screen 505 is a screen for registering the event data ED including the event date and time, and the like. The creator uses the schedule registration screen 505 to input text information corresponding to the event data ED. In the schedule registration screen 505 illustrated in FIG. 6, respective input fields are shown in a plurality of input rows. Each of the plurality of input rows corresponds to the event data ED. Input columns include an event name input field 521, a start date and time input field 523, an end date and time input field 525, and an all-day setting button 527. The input columns may include input fields other than the event name input field 521, the start date and time input field 523, and the end date and time input field 525. The input column may include a setting button other than the all-day setting button 527.

The event name input field 521 is an input field to which the event name is input. The creator inputs text information to the event name input field 521. When the photo album PA is a graduation album as an example, the creator inputs a name of an event such as an athletic meet or school trip as the event name. A name indicating an intermediate check date of the photo album PA may be input to the event name input field 521.

The start date and time input field 523 is an input field to which a start date and start time of the event is input. The start date and time input field 523 illustrated in FIG. 6 is shown as a field to which the start date is input and a field to which the start time is input, but the present disclosure is not limited thereto. The start date and time input field 523 for inputting a start date and a start time may be configured as one input field.

The end date and time input field 525 is an input field to which an end date and time of the event is input. The end date and time input field 525 illustrated in FIG. 6 is shown as a field to which an end date is input and a field to which an end time is input, but the present disclosure is not limited thereto. The end date and time input field 525 to which the end date and the end time are input may be configured as a single input field.

The all-day setting button 527 is an input button for inputting when the end time is not determined. When the creator performs an input to the all-day setting button 527, a start time and an end time of the event cannot be input. The schedule registration screen 505 illustrated in FIG. 6 shows the all-day setting button 527, but the present disclosure is not limited thereto. The schedule registration screen 505 may not include the all-day setting button 527.

A first row of the schedule registration screen 505 corresponds to a first event data ED1. A second row of the schedule registration screen 505 corresponds to a second event data ED2. A third row of the schedule registration screen 505 corresponds to a third event data ED3. The application execution unit 141 transmits each piece of event data ED to the server 10. The timer unit 33 of the server 10 acquires each piece of event data ED. The timer unit 33 generates the schedule data SD using the event data ED. The application execution unit 141 may generate event data ED that combines the first event data ED1, the second event data ED2, and the third event data ED3, and transmit the event data ED to the server 10. The timer unit 33 generates the schedule data SD including a plurality of check timings using the event data ED.

FIG. 7 illustrates the album creation screen 507, which is one of the application screens 500. FIG. 7 illustrates a first album creation screen 507A, which is an example of the album creation screen 507. The first album creation screen 507A is a screen that displays the event album PA1. For example, when the execution unit 35 of the server 10 receives the arrival signal from the timer unit 33, the execution unit 35 generates the event album PA1. The execution unit 35 transmits the generated event album PA1 to the display control unit 37. The display control unit 37 generates display data for displaying the event album PA1. The display control unit 37 transmits the display data to the personal computer 100 via the server communication unit 20. The application execution unit 141 of the personal computer 100 acquires the display data and causes the event album PA1 to be displayed on the display unit 120. The screen generation unit 143 displays the event album PAL on the first album creation screen 507A. The first album creation screen 507A displays the event album PA1.

The first album creation screen 507A illustrated in FIG. 7 displays a part of the event album PA1 and a page forwarding icon 531. The first album creation screen 507A illustrated in FIG. 7 displays one of a plurality of pages of the event album PA1. The first album creation screen 507A may display a plurality of pages that are two or more pages. The first album creation screen 507A may display the photo album PA.

The page forwarding icon 531 is operated when the creator switches between pages of the event album PA1 displayed on the first album creation screen 507A. When the creator operates the page forwarding icon 531, the pages of the event album PA1 displayed on the first album creation screen 507A are switched.

The event album PA1 of one page displayed on the first album creation screen 507A illustrated in FIG. 7 includes a first captured image PG1, a second captured image PG2, and an event name display 533. The event album PA1 may display captures, other comments, illustrations, and the like of the captured image PG (not shown).

The captured image PG displayed in the event album PA1 in the first album creation screen 507A is selected by the execution unit 35 of the server 10, as an example. The event name display 533 is created by the execution unit 35 of the server 10. The creator can check and edit the content of the event album PA1 on the first album creation screen 507A. The creator may perform replacement of the captured image PG and layout change. The creator may change a terminology of the event name display 533 and change a display position, for example.

FIG. 8 illustrates the album creation screen 507, which is one of the application screens 500. FIG. 8 illustrates a second album creation screen 507B, which is an example of the album creation screen 507. The second album creation screen 507B is a screen that displays information related to the analysis data AD in the server 10. For example, when the execution unit 35 of the server 10 receives the arrival signal from the timer unit 33, the execution unit 35 generates the analysis data AD. The execution unit 35 transmits the generated analysis data AD to the display control unit 37. The display control unit 37 generates display data for displaying the information related to the analysis data AD. The display control unit 37 transmits the display data to the personal computer 100 via the server communication unit 20. The application execution unit 141 of the personal computer 100 acquires the display data and causes the information related to the analysis data AD to be displayed on the display unit 120. The screen generation unit 143 causes the information related to the analysis data AD to be displayed on the second album creation screen 507B. The second album creation screen 507B displays the information related to the analysis data AD.

The second album creation screen 507B illustrated in FIG. 8 displays an evaluation result list 535. The evaluation result list 535 shows the information related to the analysis data AD. The evaluation result list 535 illustrated in FIG. 8 shows the information related to the analysis data AD at a point in time when the event 1 has ended. The evaluation result list 535 shows the identification code CN, the number of imaging cases, an evaluation point, and a file name. The evaluation result list 535 shows the number of imaging cases, an evaluation point, and a file name for each identification code CN. The evaluation result list 535 may include items other than the number of imaging cases, the evaluation point, and the file name for each identification code CN. The creator can check, for example, the number of captured images PG captured by each subject by visually recognizing the evaluation result list 535. The creator can recognize which subject should be mainly imaged at the time of a next event.

The identification code CN included in the evaluation result list 535 is the identification code CN registered on the member registration screen 503. When the identification data generation unit 31 newly generates the identification data MD related to the unregistered subject, the identification code CN corresponding to the unregistered subject is added to the evaluation result list 535.

The number of imaging cases is the number of pieces of imaging data PD including a predetermined subject. The number of imaging cases in each row is the number of pieces of imaging data PD for each subject corresponding to the identification code CN. The number of imaging cases is the number of pieces of imaging data PD including the subject image HG of the subject among the imaging data PD stored in the server storage unit 50. The number of imaging cases may be the number of pieces of imaging data PD including the subject image HG of the subject among the imaging data PD showing a plurality of captured images PG included in the event album PA1.

The evaluation point is an evaluation value obtained by converting the analysis information of the execution unit 35 into a point. The evaluation point in each row is an evaluation value of the subject corresponding to the identification code CN. The evaluation point is calculated from the analysis information obtained by analyzing the imaging data PD stored in the server storage unit 50. The evaluation point may be calculated from the analysis information obtained by analyzing the imaging data PD showing the plurality of captured images PG included in the event album PA1.

The file name is a file name of the imaging data PD including the subject. The file name of each row is a file name of the imaging data PD including the subject corresponding to the identification code CN. The file name is a file name of the imaging data PD including the subject image HG of the subject among the pieces of imaging data PD stored in the server storage unit 50. The file name may be a file name of the imaging data PD including the subject image HG of the subject among the pieces of imaging data PD representing the plurality of captured images PG included in the event album PA1.

The evaluation result list 535 illustrated in FIG. 8 shows a file name, but the present disclosure is not limited thereto. The evaluation result list 535 may indicate a display position of the captured image PG displayed in the event album PA1 instead of the file name. The position of the captured image PG displayed in each row is a display position of the captured image PG including the subject image HG of the subject corresponding to the identification code CN. The evaluation result list 535 may display the captured image PG instead of the file name. The evaluation result list 535 may not display the file name.

FIG. 9 illustrates the album creation screen 507, which is one of the application screens 500. FIG. 9 illustrates a third album creation screen 507C, which is an example of the album creation screen 507. The third album creation screen 507C is a screen that displays the information related to the analysis data AD in the server 10, and the warning message 537. For example, when the execution unit 35 of the server 10 receives the arrival signal from the timer unit 33, the execution unit 35 generates the analysis data AD. The execution unit 35 compares the analysis data AD with the reference data RD. When the execution unit 35 determines that the analysis data AD does not satisfy the reference data RD, the execution unit 35 generates warning information. The execution unit 35 transmits the generated analysis data AD to the display control unit 37. When the execution unit 35 generates warning information, the execution unit 35 transmits the warning information to the display control unit 37. The display control unit 37 generates display data for displaying the information related to the analysis data AD. The display control unit 37 generates warning message data based on the warning information. The display control unit 37 transmits the display data and the warning message data to the personal computer 100 via the server communication unit 20. The application execution unit 141 of the personal computer 100 acquires the display data and the warning message data, and causes the information related to the analysis data AD and the warning message 537 to be displayed on the display unit 120. The screen generation unit 143 displays the information related to the analysis data AD and the warning message 537 on the third album creation screen 507C. The third album creation screen 507C displays the information related to the analysis data AD and the warning message 537.

The evaluation result list 535 displayed on the third album creation screen 507C in FIG. 9 is the same as the evaluation result list 535 displayed on the second album creation screen 507B illustrated in FIG. 8. The evaluation result list 535 displayed on the third album creation screen 507C may be the same as the evaluation result list 535 displayed on the second album creation screen 507B, or may have a different configuration. The third album creation screen 507C may not display the evaluation result list 535. It is preferable for the third album creation screen 507C to display the evaluation result list 535. When the evaluation result list 535 is displayed on the third album creation screen 507C, the creator can easily check details of the warning message 537.

The warning message 537 indicates that the analysis data AD does not satisfy the reference data RD. As an example, the warning message 537 is displayed on the third album creation screen 507C when the number of pieces of the imaging data PD including the subject does not satisfy the reference data RD. Here, the reference data RD to be compared with the number of pieces of the imaging data PD is a numerical value range including an average value of the numbers of pieces of the imaging data PD for the plurality of subjects.

Text information included in the warning message 537 can be set appropriately. The warning message 537 illustrated in FIG. 9 indicates the number of pieces of the imaging data PD as the number of imaging cases. The reference data RD is expressed as a comparison value. The warning message 537 includes a comment to the creator that the number of pieces of the imaging data PD of the subject corresponding to the identification code CN increases in a next event. The creator can recognize which subject should be mainly imaged at the next event by visually recognizing the warning message 537.

The warning message 537 is displayed on the third album creation screen 507C, but the present disclosure is not limited thereto. When the personal computer 100 receives the warning message data from the server 10, the warning message 537 may be displayed on any one of the album creation screens 507. When the personal computer 100 receives the warning sound data, the personal computer 100 may output a warning sound.

FIG. 10 illustrates the album creation screen 507, which is one of the application screens 500. FIG. 10 illustrates a fourth album creation screen 507D, which is an example of the album creation screen 507. The fourth album creation screen 507D is a screen that is displayed when the server 10 outputs the plurality of event albums PAL to the personal computer 100. The fourth album creation screen 507D is a screen that is displayed in place of the first album creation screen 507A. For example, when the execution unit 35 of the server 10 receives the arrival signal from the timer unit 33, the execution unit 35 generates the first event album PALA and the second event album PA1B. The execution unit 35 transmits the generated first event album PALA and second event album PA1B to the display control unit 37. The display control unit 37 generates display data for displaying the first event album PA1A and display data for displaying the second event album PA1B. The display control unit 37 transmits the two pieces of display data to the personal computer 100 via the server communication unit 20. The application execution unit 141 of the personal computer 100 acquires the two pieces of display data and causes the first event album PALA and the second event album PA1B to be displayed on the display unit 120. The screen generation unit 143 causes the first event album PALA and the second event album PA1B to be displayed on the fourth album creation screen 507D. The fourth album creation screen 507D displays the first event album PALA and the second event album PA1B.

The fourth album creation screen 507D illustrated in FIG. 10 displays a part of the first event album PALA, a part of the second event album PA1B, and two page forwarding icons 531. The fourth album creation screen 507D illustrated in FIG. 10 displays one of a plurality of pages constituting the first event album PALA. The fourth album creation screen 507D displays one of a plurality of pages constituting the second event album PA1B.

The two page forwarding icons 531 correspond to the first event album PALA and the second event album PA1B, respectively. The page forwarding icon 531 has the same function as the page forwarding icon 531 displayed on the first album creation screen 507A.

The server 10 includes the identification data generation unit 31 that acquires the subject data HD for identifying the subject, the server storage unit 50 that acquires the plurality of pieces of the imaging data PD, the timer unit 33 that sets the check timing at which the imaging data PD is checked, and the execution unit 35 that generates the photo album PA. The execution unit 35 identifies the subject included in the imaging data PD using the subject data HD, and generates the analysis data AD related to the identified subject. The execution unit 35 compares the analysis data AD of the subject with the reference data RD at the check timing, and outputs the warning message 537 indicating that the analysis data AD does not satisfy the reference data RD when the analysis data AD does not satisfy the reference data RD.

The creator can ascertain that it is difficult to create a desired photo album PA with the plurality of pieces of the imaging data PD stored in the server 10. The desired photo album PA is, for example, an album in which the numbers of captured images PG including respective subjects among the plurality of captured images PG are equal or approximately equal. The server 10 can notify the creator that it is difficult to create the desired photo album PA with the stored imaging data PD.

The execution unit 35 preferably generates the event album PA1 constituting a part of the photo album PA and including the imaging data PD at the check timing.

The creator can check and edit a part of the photo album PA at a preset timing.

The analysis data AD is the number of pieces of the imaging data PD including the subject among the plurality of pieces of the imaging data PD. The reference data RD is the lower limit of the number of pieces of the imaging data PD. The warning message data preferably indicates that the number of pieces of the imaging data PD does not exceed the lower limit of the number of pieces of the imaging data PD.

The creator may determine a subject of which the number of pieces of imaging data PD is small among the plurality of subjects.

The photo album creation system 1 includes the server 10 including the identification data generation unit 31 that acquires the identification data MD for identifying the subject, the server storage unit 50 that acquires the plurality of pieces of the imaging data PD, the timer unit 33 that sets the check timing at which the imaging data PD is checked, and the execution unit 35 that generates the photo album PA, and the personal computer 100 operated by the creator. The execution unit 35 identifies the subject included in the imaging data PD using the identification data MD and stores the analysis data AD related to the identified subject. The execution unit 35 compares the stored analysis data AD with the reference data RD at the check timing. When the analysis data AD does not satisfy the reference data RD, the execution unit 35 outputs the warning message 537 indicating that the reference data RD is not satisfied to the personal computer 100. The personal computer 100 receives the warning message 537 and displays the warning message.

The creator can ascertain that it is difficult to create the desired photo album PA with the plurality of stored pieces of imaging data PD. The server 10 can notify the creator that it is difficult to create the desired photo album PA with the stored imaging data PD.

### First Embodiment

A first embodiment illustrates a photo album creation method for identifying the imaging data PD stored in the server storage unit 50 and notifying the creator of a warning message or the like. The photo album creation method corresponds to an example of an image processing method. The server 10 compares the analysis data AD generated based on the imaging data PD stored in the server storage unit 50 with the reference data RD. The server 10 outputs the warning message 537 depending on a comparison result of the analysis data AD.

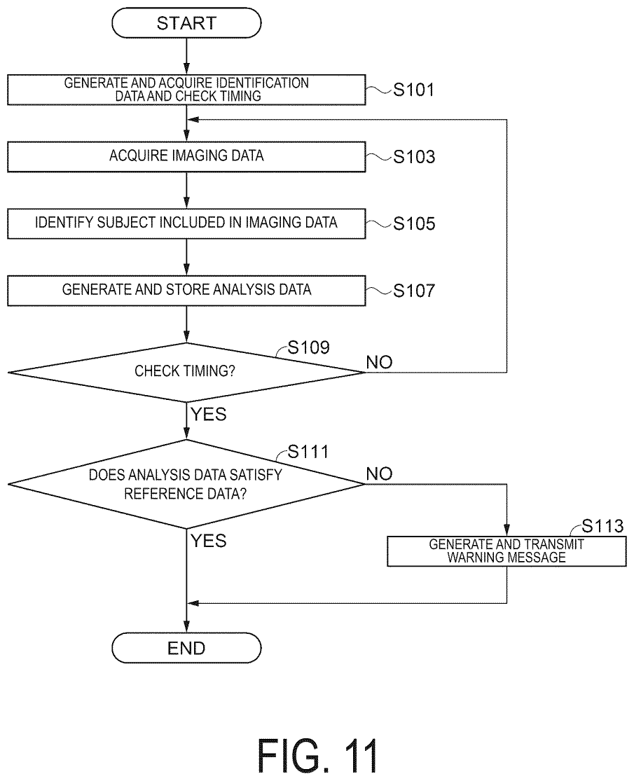

FIG. 11 illustrates a control flow that is performed by the server 10. FIG. 11 illustrates the control flow in a flowchart. The server 10 receives various types of registration data from the personal computer 100. The server 10 receives the imaging data PD from the digital camera 200 or the like.

In step S101, the server 10 generates and acquires the identification data MD and the check timing. The creator uses the personal computer 100 to perform various registrations in a preparation stage when the photo album PA is created. The server 10 acquires the registration data of the creator and generates the identification data MD and the check timing. The server 10 acquires the identification data MD and the check timing by generating the identification data MD and the check timing.

The creator inputs the subject data HD to the member registration screen 503 illustrated in FIG. 5. The creator inputs the identification code CN, the registered image RG, notes, and the like for each subject. The application execution unit 141 of the personal computer 100 generates the subject data HD for each subject using the input data. The application execution unit 141 causes the PC communication unit 110 to transmit the subject data HD. The PC communication unit 110 transmits the subject data HD to the server 10 via the communication network NW. The server communication unit 20 of the server 10 receives the subject data HD. The server communication unit 20 transmits the subject data HD to the identification data generation unit 31 of the server control unit 30.

The identification data generation unit 31 receives the subject data HD. The identification data generation unit 31 generates the identification data MD using the subject data HD. As an example, the identification data generation unit 31 performs various analyses on the registered image RG included in the subject data HD to generate the identification data MD. The identification data generation unit 31 stores the identification data MD in the server storage unit 50 in advance.

The creator inputs the event data ED to the schedule registration screen 505 illustrated in FIG. 6. The creator inputs an event name, start date and time of the event, end date and time of the event, and the like for each event. The creator may also input the intermediate check date. The application execution unit 141 generates the event data ED for each event or intermediate check date using the input data. The application execution unit 141 causes the PC communication unit 110 to transmit the event data ED. The PC communication unit 110 transmits the event data ED to the server communication unit 20 via the communication network NW. The server communication unit 20 receives the event data ED. The server communication unit 20 transmits the event data ED to the timer unit 33.

The timer unit 33 receives the event data ED. The timer unit 33 uses the event data ED to set one or more check timings. The timer unit 33 generates the schedule data SD including the one or more check timings. The timer unit 33 stores the schedule data SD in the server storage unit 50. The execution unit 35 appropriately reads the schedule data SD from the server storage unit 50 and acquires the check timings.

The server 10 acquires the imaging data PD in step S103 after generating and acquiring the identification data MD and the check timing. The server communication unit 20 receives the imaging data PD transmitted from the digital camera 200 and the smartphone 300. The server communication unit 20 may receive the imaging data PD from the personal computer 100. The server communication unit 20 transmits the imaging data PD to the server storage unit 50. The server storage unit 50 acquires the imaging data PD by receiving the imaging data PD from the server communication unit 20. The server storage unit 50 stores the imaging data PD.

The server 10 identifies the subject included in the imaging data PD in step S105 after acquiring the imaging data PD. The execution unit 35 reads the identification data MD from the server storage unit 50. As an example, the execution unit 35 performs face authentication on the face image included in the face image region FR in the imaging data PD using the identification data MD. The execution unit 35 identifies each subject image HG included in the imaging data PD by performing the face authentication. The execution unit 35 generates identification information for identifying the subject image HG for each piece of the imaging data PD. The execution unit 35 may analyze a posture, a position, and the like of the subject image HG to generate analysis information.

The server 10 generates and stores the analysis data AD in step S107 after identifying the subject included in the imaging data PD. The execution unit 35 generates the analysis data AD including, for example, the number of pieces of the imaging data PD of each subject using the identification information. The execution unit 35 generates and updates the analysis data AD when the identification information has been generated for the imaging data PD. The execution unit 35 may acquire the identification information at a predetermined timing and generate the analysis data AD. The execution unit 35 may generate the analysis data AD including the analysis information. The execution unit 35 stores the generated analysis data AD in the server storage unit 50. The server storage unit 50 stores the analysis data AD.

The server 10 determines whether or not the check timing has arrived in step S109 after generating and storing the analysis data AD. The execution unit 35 reads the schedule data SD from the server storage unit 50. The execution unit 35 acquires the check timing included in the schedule data SD. The execution unit 35 determines whether or not the check timing has arrived. When the execution unit 35 determines that the check timing has arrived, the execution unit 35 proceeds to step S111 (step S109: YES). When the execution unit 35 determines that the check timing has not arrived, the execution unit 35 returns to step S103 (step S109: NO).

In step S111, the execution unit 35 determines whether or not the analysis data AD satisfies the reference data RD. The execution unit 35 acquires the reference data RD in advance. The reference data RD is a predetermined value or a value calculated using identification information. The execution unit 35 compares the analysis data AD with the reference data RD. The execution unit 35 determines whether or not the analysis data AD satisfies the reference data RD. As an example, the execution unit 35 determines whether or not the number of pieces of the imaging data PD of each subject included in the analysis data AD is equal to or larger than a predetermined set number of the imaging data PD. When the number of pieces of the imaging data PD of each subject is larger than the set number, the execution unit 35 determines that the analysis data AD satisfies the reference data RD. When the number of pieces of the imaging data PD of each subject is smaller than the set number, the execution unit 35 determines that the analysis data AD does not satisfy the reference data RD. When the execution unit 35 determines that the analysis data AD does not satisfy the reference data RD, the execution unit 35 proceeds to step S113 (step S111: NO). When the execution unit 35 determines that the analysis data AD satisfies the reference data RD, the execution unit 35 ends the processing (step S111: YES).

In step S113, the server 10 generates and transmits the warning message 537. When the execution unit 35 determines that the analysis data AD does not satisfy the reference data RD, the execution unit 35 generates warning information. The execution unit 35 transmits the warning information to the display control unit 37. When the display control unit 37 receives the warning information, the display control unit 37 generates warning message data including the warning message 537. The display control unit 37 transmits the warning message data to the server communication unit 20. The server communication unit 20 transmits the warning message data to the personal computer 100 via the communication network NW. The server 10 causes the personal computer 100 to display the warning message by transmitting the warning message data to the personal computer 100.

The photo album creation method includes acquiring the identification data MD for identifying the subject included in the imaging data PD and the check timing at which the imaging data PD is checked, acquiring a plurality of the imaging data PD, identifying the subject included in the imaging data PD using the identification data MD, storing the analysis data AD related to the identified subject, comparing the stored analysis data AD with the reference data RD at the check timing, and outputting the warning message 537 indicating that the analysis data AD does not satisfy the reference data RD when the analysis data AD does not satisfy the reference data RD.

The creator can ascertain that it is difficult to create the desired photo album PA with the plurality of stored pieces of imaging data PD. The server 10 can notify the creator that it is difficult to create the desired photo album PA with the stored imaging data PD.

### Second Embodiment

A second embodiment shows a photo album creation method of identifying the imaging data PD included in the event album PA1 and notifying the creator of a warning message or the like. The server 10 compares the analysis data AD generated based on the imaging data PD included in the event album PA1 with the reference data RD. The server 10 outputs the warning message 537 depending on the comparison result.

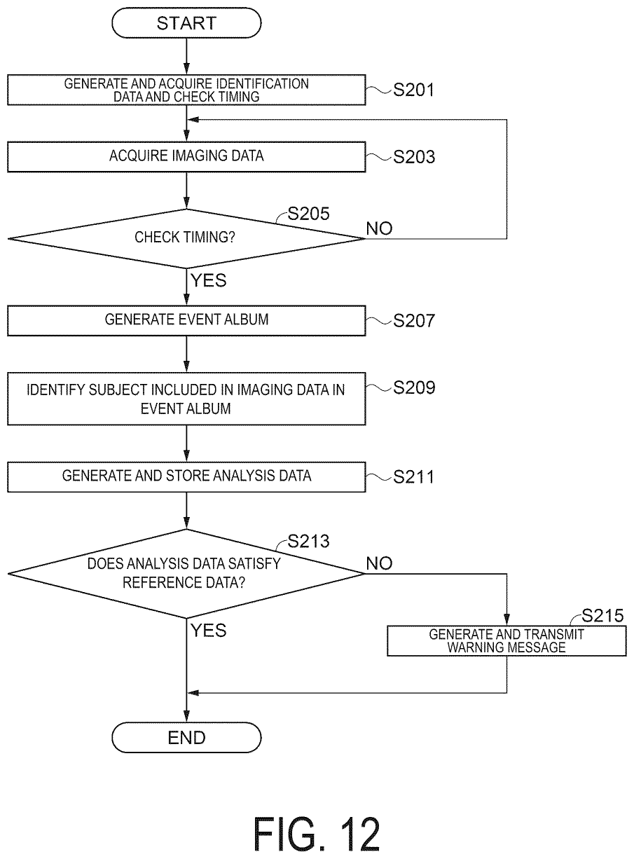

FIG. 12 illustrates a control flow that is performed by the server 10. FIG. 12 illustrates the control flow in a flowchart. The server 10 receives various types of registration data from the personal computer 100. The server 10 receives the imaging data PD from the digital camera 200 or the like.

In step S201, the server 10 generates and acquires the identification data MD and the check timing. The creator uses the personal computer 100 to perform various registrations in a preparation stage when the photo album PA is created. The server 10 acquires the registration data of the creator and generates the identification data MD and the check timing. The server 10 acquires the identification data MD and the check timing by generating the identification data MD and the check timing.

The server 10 acquires the imaging data PD in step S203 after generating and acquiring the identification data MD and the check timing. The server communication unit 20 receives the imaging data PD transmitted from the digital camera 200 and the smartphone 300. The server communication unit 20 may receive the imaging data PD from the personal computer 100. The server communication unit 20 transmits the imaging data PD to the server storage unit 50. The server storage unit 50 acquires the imaging data PD by receiving the imaging data PD from the server communication unit 20. The server storage unit 50 stores the imaging data PD.

The server 10 determines whether or not the check timing has arrived in step S205 when acquiring the imaging data PD. The execution unit 35 reads the schedule data SD from the server storage unit 50. The execution unit 35 acquires the check timing included in the schedule data SD. The execution unit 35 determines whether or not the check timing has arrived. When the execution unit 35 determines that the check timing has arrived, the execution unit 35 proceeds to step S207 (step S205: YES). When the execution unit 35 determines that the check timing has not arrived, the execution unit 35 returns to step S203 (step S205: NO).

The server 10 generates the event album PAL in step S207 after the check timing has arrived. As an example, the execution unit 35 generates the event album PA1 based on preset setting conditions. The execution unit 35 may transmit an album creation instruction to create the event album PA1 to the personal computer 100, and cause the creator to create the event album PA1. The event album PA1 is created using the imaging data PD stored in the server storage unit 50.

The server 10 identifies the subject included in the imaging data PD in the event album PAL in step S209 after generating the event album PA1. The execution unit 35 reads the identification data MD from the server storage unit 50. As an example, the execution unit 35 performs face authentication on the face image included in the face image region FR in the imaging data PD using the identification data MD. The execution unit 35 identifies each subject image HG included in the imaging data PD by performing face authentication. The execution unit 35 generates identification information for identifying the subject image HG for each piece of the imaging data PD. The execution unit 35 may analyze a posture, a position, and the like of the subject image HG to generate analysis information.

The server 10 generates and stores the analysis data AD in step S211 after identifying the subject included in the imaging data PD. The execution unit 35 generates the analysis data AD including, for example, the number of pieces of the imaging data PD of each subject using the identification information. The execution unit 35 generates and updates the analysis data AD when the identification information has been generated for the imaging data PD. The execution unit 35 may acquire the identification information at a predetermined timing and generate the analysis data AD. The execution unit 35 may generate the analysis data AD including the analysis information. The execution unit 35 stores the generated analysis data AD in the server storage unit 50. The server storage unit 50 stores the analysis data AD.

The analysis data AD is preferably information related to the subjects in the imaging data PD included in the event album PA1.

The server 10 can create the desired photo album PA by identifying the imaging data PD used in the event album PA1.

In step S213, the execution unit 35 determines whether or not the analysis data AD satisfies the reference data RD. The execution unit 35 acquires the reference data RD in advance. The reference data RD is a predetermined value or a value calculated using identification information. The execution unit 35 compares the analysis data AD with the reference data RD. The execution unit 35 determines whether or not the analysis data AD satisfies the reference data RD. As an example, the execution unit 35 determines whether or not the number of pieces of the imaging data PD of each subject included in the analysis data AD is equal to or larger than a predetermined set number of the imaging data PD. When the number of pieces of the imaging data PD of each subject is larger than the set number, the execution unit 35 determines that the analysis data AD satisfies the reference data RD. When the number of pieces of the imaging data PD of each subject is smaller than the set number, the execution unit 35 determines that the analysis data AD does not satisfy the reference data RD. When the execution unit 35 determines that the analysis data AD does not satisfy the reference data RD, the execution unit 35 proceeds to step S215 (step S213: NO). When the execution unit 35 determines that the analysis data AD satisfies the reference data RD, the execution unit 35 ends the processing (step S213: YES).

In step S215, the server 10 generates and transmits the warning message 537. When the execution unit 35 determines that the analysis data AD does not satisfy the reference data RD, the execution unit 35 generates warning information. The execution unit 35 transmits the warning information to the display control unit 37. When the display control unit 37 receives the warning information, the display control unit 37 generates warning message data including the warning message 537. The display control unit 37 transmits the warning message data to the server communication unit 20. The server communication unit 20 transmits the warning message data to the personal computer 100 via the communication network NW. The server 10 causes the personal computer 100 to display the warning message by transmitting the warning message data to the personal computer 100.

What is claimed is:

1. An image processing device comprising:
an identification information acquisition unit configured to acquire identification information for identifying a person;
an image acquisition unit configured to acquire a plurality of images;
a setting unit configured to set a check timing at which the images are checked; and
a control unit configured to generate an album, wherein
the control unit
identifies the person included in the images using the identification information,
generates person information related to the identified person,
compares the person information of the person with set information at the check timing, and
outputs notification information indicating that the person information does not satisfy the set information, when the person information does not satisfy the set information.

2. The image processing device according to claim 1, wherein the control unit generates a partial album constituting a part of the album and including the image at the check timing.

3. The image processing device according to claim 2, wherein the person information is information related to the person in the image included in the partial album.

4. The image processing device according to claim 2, wherein the control unit generates a first candidate and a second candidate as the partial album, and outputs the first candidate and the second candidate.

5. The image processing device according to claim 1, wherein
the identification information includes a person image related to the person, and
the identification information acquisition unit generates model information using the person image.

6. The image processing device according to claim 1, wherein the identification information acquisition unit generates the identification information using the image acquired by the image acquisition unit.

7. The image processing device according to claim 1, wherein the control unit generates and outputs print data for printing the generated album.

8. The image processing device according to claim 1, wherein
the person information is the number of images including the person among the plurality of images,
the set information is a threshold for the number of images, and
the notification information indicates that the number of images does not exceed the threshold.

9. An image processing method comprising:
acquiring identification information for identifying a person included in an image, and a check timing at which the image is checked;
acquiring a plurality of the images;
identifying the person included in the images using the identification information;
storing person information related to the identified person;
comparing the stored person information with set information at the check timing; and
outputting notification information indicating that the person information does not satisfy the set information, when the person information does not satisfy the set information.

10. An image processing system comprising:
an image processing device including an identification information acquisition unit configured to acquire identification information for identifying a person, an image acquisition unit configured to acquire a plurality of images, a setting unit configured to set a check timing at which the images are checked, and a control unit configured to generate an album; and
an input and output device operated by a user, wherein
the control unit
identifies the person included in the images using the identification information,
stores person information related to the identified person,
compares the stored person information with set information at the check timing, and
outputs notification information indicating that the person information does not satisfy the set information to the input and output device, when the person information does not satisfy the set information, and
the input and output device receives the notification information and displays the notification information.
